(19) United States
(12) Patent Application Publication
(10) Pub. No.: US 2009/0079392 A1
(43) Pub. Date: Mar. 26, 2009

(54) Portable power supply module with winding unit

(76) Inventor: Michael Wu, Hsin Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/007,711

(22) Filed: Jan. 15, 2008

(30) Foreign Application Priority Data
Sep. 26, 2007 (TW) 96216064

(51) Int. Cl. H02J 7/00

(52) U.S. Cl. 320/127

(57) ABSTRACT

A portable power supply module with winding unit comprises a shell body, a battery room, at least one battery unit, a connection line with predetermined extension length and an output connector. The shell body is provided with a winding area and an output connector accommodation room. The battery room is provided with a set of conductive contact plates which electrically connect with a circuit board. The connection line is electrically connected with the circuit board, extended beyond the shell body and connected with the output connector. The connection line can be wound around and received in the winding area of the shell body and the output connector is accommodated in the output connector accommodation room of the shell body.

### FIELD OF THE INVENTION

The present invention relates to a portable power supply module, particularly to a portable power supply module with winding unit to wind and receive a connection line and an output connector.

### BACKGROUND OF THE INVENTION

With the rapid development of technology, nowadays many electronic devices are designed to be portable to enable people to use at anywhere, such as mobile phone, notebook computer, walkman, USB flash drive, personal digital assistant, digital camera etc. These electronic devices are commonly used to manage and handle works in business and have become the essential tools in commercial offices. T he portable electronic devices generally process multiple functions and are complicated. When using the portable electronic device, a major problem would be the shortage of power. How to immediately supply power to the electronic devices is an important issue that has to be solved. Some prior arts disclosed solutions to the problem.

Taiwan Invention Patent No. 200711256 discloses a portable charging device which is installed in the notebook computer or other portable electronic device to recharge the small electronic device and increase the working time of the small electronic device. The portable charging device comprises a battery, a charging switch and a charging cable. The battery is a rechargeable battery for notebook computer or other portable electronic device to provide the power required by the notebook computer or other portable electronic device at operation. The charging cable is used to connect the small electronic device and the charging switch is connected between the battery and the charging cable to control the charging power to small electronic device.

Taiwan Invention Patent No. 200637101 discloses a portable charging device of a portable electronic device, aiming to solve the problem of the traditional charger of a portable electronic device that can only rely on a public power supply system to obtain electricity, and the problem of preparing different chargers for different portable electronic devices, and the problem of increasing the required room and the weight when using many auxiliary power supply devices that increase. The portable charging device comprises a charging base, a back plate assembly, a loaded base, and the battery cores arranged in the charging base. The loaded base is assembled by an auxiliary positioning mechanism. A portable electronic device that is needed to be charged can be loaded in the loaded base and can be connected to the connector on the charging base to obtain electricity

Furthermore, Taiwan Invention Patent No. 200614626 discloses a convenient and economical portable charger which is compact and able to be held in the hand. It can charge a portable electronic device via an external connector which transmits data to the electronic device or receives data from the electronic device by using an embedded secondary battery to provide electricity. Herewith, it is more convenient to charge the portable electronic device.

Such a kind of electronic device mainly relies on the built-in power supply, for example the lithium or nickel cadmium battery system built in the mobile phone. However, for different kinds of electronic devices, the battery charging devices of the electronic devices may be the same, or may be different from each other and cannot be used interchangeably. Under such a circumstance, the user has to prepare a plurality of batteries for different devices and charging devices thereof. Consequently, it causes the inconveniences for carrying and storing the charging devices.

Furthermore, though many portable charging devices have been invented, such a kind of portable charging device is generally provided with at least a charging device and connection line thereof, but they do not provide storage room for accommodating the connection line. This kind of portable charging device is generally divided into two types. For the first type, the connection line and charging device is separable from each other. The two ends of the connection line are respectively connected to the charging device and the electronic device during charging. The second type is an integrated design that the charging device is connected with the connection line thereof.

Regarding the first type, because the connection line is separable, it will be more troublesome in carrying and has the risk of getting lost. Besides, it occupies space in carrying. Regarding the second type, because the connection line is connected with the charging device, there is no risk of losing the connection line. However, the connection point, where the connection line connects to the charging device, is liable for damage as being stored in a closed space and pressed for a long time. Also it has the same drawback of occupying space for carrying.

### SUMMARY OF THE INVENTION

Therefore, a primary objective of the present invention is to provide a portable power supply module which provides the required power by applying a conventional battery as a power supply source via a connection line and an output connector to connect with the electronic device to be charged.

Another objective of the present invention is to provide a portable power supply module with winding unit. The connection line of the portable power supply module and the output connector can be received completely in a winding area and an output connector accommodation room of the portable power supply module.

By means of the technical means adopted by the present invention, all kinds of electronic devices can be charged rapidly via the portable power supply module of the present invention. Additionally, an output connector with a universal transmission interface (for example USB interface) can be applied to various electronic devices having the transmission interface.

The present invention can also utilize a winding area of the shell body to receive the connection line. It can also accommodate the output connector in the output connector accommodation room. Such a design can decrease the space occupied by the connection line and the output connector and be convenient for carry. It also can reduce the damages caused by pressing or impact to the connection line and output connector.

### BRIEF DESCRIPTION OF THE DRAWINGS

FIG. 1 is a perspective view of a portable power supply module according to a first embodiment of the present invention;

FIG. 2 is an exploded perspective view of the portable power supply module of FIG. 1;

FIG. 3 is a schematic diagram showing that a connection line and an output connector are pulled out of a shell body of the portable power supply module of FIG. 1;

FIG. 4 is a schematic diagram showing that the connection line and the output connector are placed within the shell body of the portable power supply module of FIG. 1;

FIG. 5 is a perspective view of a portable power supply module according to a second embodiment of the present invention;

FIG. 6 is an exploded perspective view of the portable power supply module of FIG. 5;

FIG. 7 is a schematic diagram showing that a connection line and an output connector are pulled out of a shell body of the portable power supply module of FIG. 5; and

FIG. 8 is a schematic diagram showing that the connection line and the output connector are placed within the shell body of the portable power supply module of FIG. 5.

### DETAILED DESCRIPTION OF THE PREFERRED EMBODIMENT

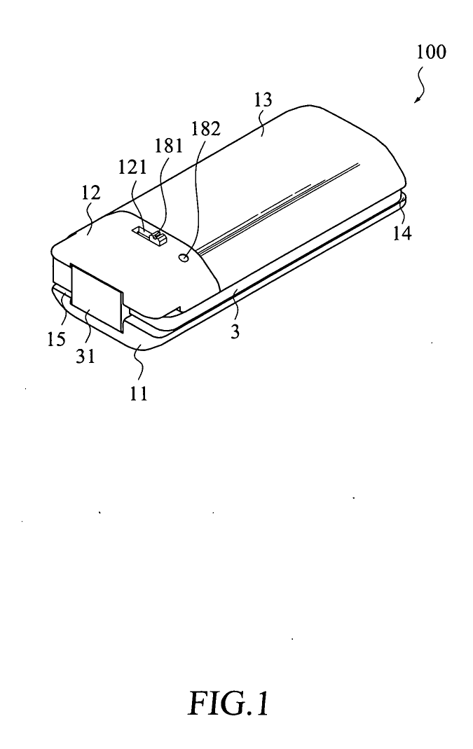

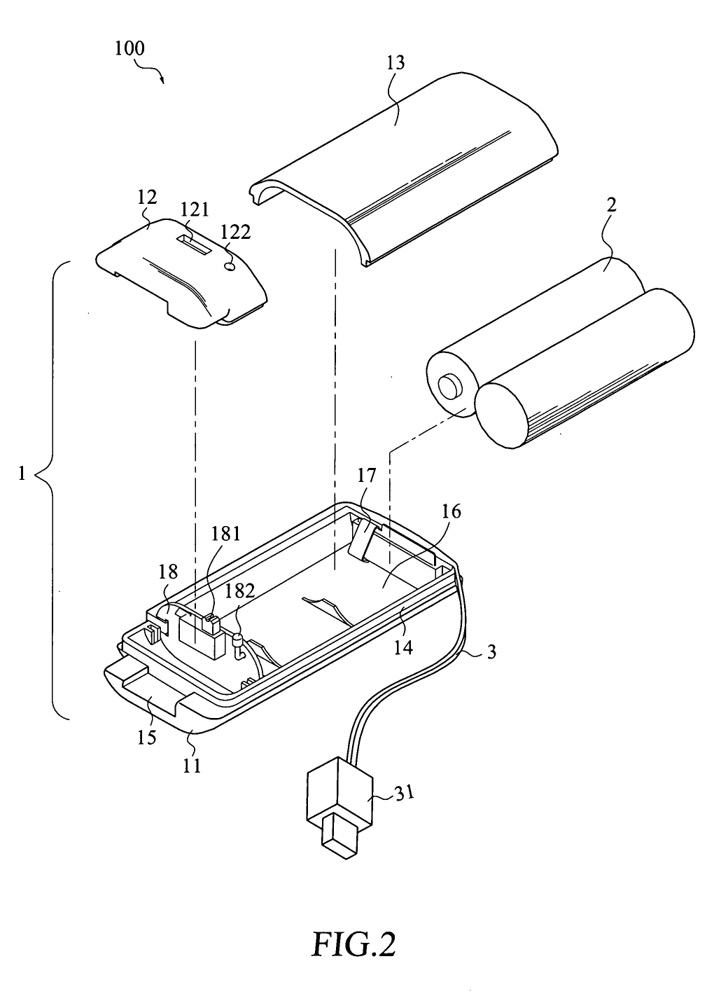

Referring to FIG. 1 and FIG. 2, FIG. 1 shows a perspective view of a portable power supply module with winding unit according to a first embodiment of the present invention. FIG. 2 shows an exploded view of the portable power supply module of the first embodiment.

As shown in the drawings, a portable power supply module 100 comprises a shell body 1. The shell body 1 comprises a base 11, a first lid 12 and a second lid 13, wherein the first lid 12 is provided with a switch slot 121 having a predetermined size and a power supply indicating lamp hole 122. The first lid 12 and the second lid 13 can be fastened tightly to the base 11 correspondingly to form the shell body 1.

The shell body 1 is provided with a winding area 14 and an output connector accommodation room 15. The winding area 14 is a groove extending laterally along the periphery of the shell body 1, which it is close to the boundary where the base 11 contacts with the first lid 12 and where the base 11 contacts with the second lid 13. The output connector accommodation room 15 is a space with predetermined size and communicated with the winding area 14 and formed at a lateral side of the shell body 1 between the base 11 and the first lid 12.

The base 11 is provided with a battery room 16 in its interior and a set of electrically conductive contact plates 17 as well. The conductive contact plates 17 are electrically connected with a circuit board 18. The circuit board 18 is provided with a power switch 181 and a corresponding power indicating lamp 182. The power switch 181 controls the operation of the portable power supply module 100 and drives the power indicating lamp 182 to turn on or off. A battery unit 2 is received in the battery room 16. The battery unit 2 contacts the conductive contact plates 17 via the two electrodes of the battery unit 2 respectively to provide power through the conductive contact plates 17.

The portable power supply module 100 is provided with a connection line 3 having a predetermined length to electrically connect with the circuit board 18 and passes through the shell body 1 to extend outside the shell body 1. The other end of the connection line 3 connects with an output connector 31. The output connector 31 may comprise a USB interface connection plug. From the power supplied by the battery unit 2, the portable power supply module 100 provides power through the connection line 3 and the circuit board 18 electrically connected with the conductive contact plates 17. Also, by plugging the output connector 31 to an electrical appliance having a USB slot and turning on the power switch 181, the electrical appliance is charged.

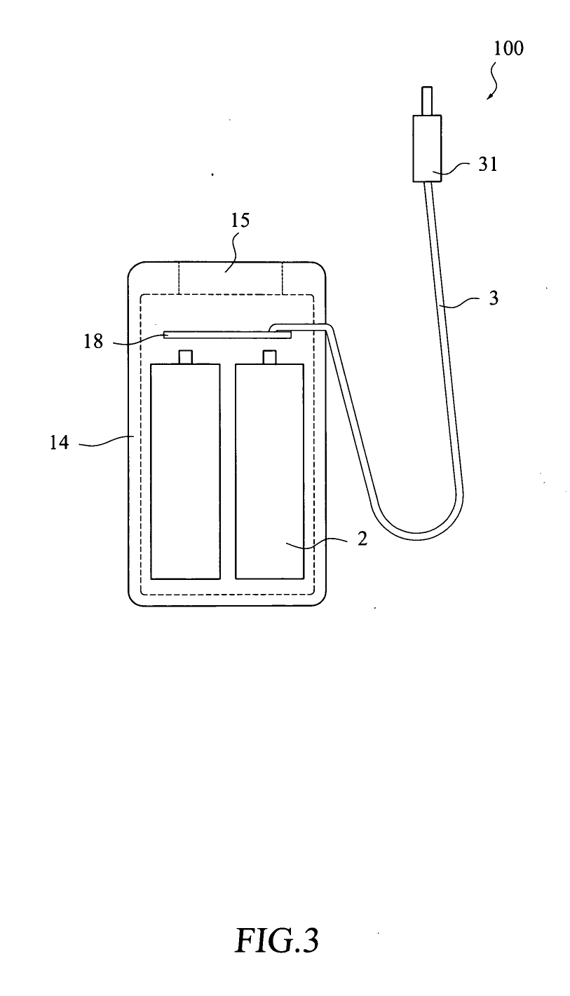

Referring to FIG. 3, FIG. 3 is a schematic diagram showing that the connection line and the output connector are pulled out from the shell body of the first embodiment. As shown, when the portable power supply module 100 is used, the connection line 3 and the output connector 31 can be taken out to facilitate the electrical connection between the output connector 31 and the electrical appliance to be charged.

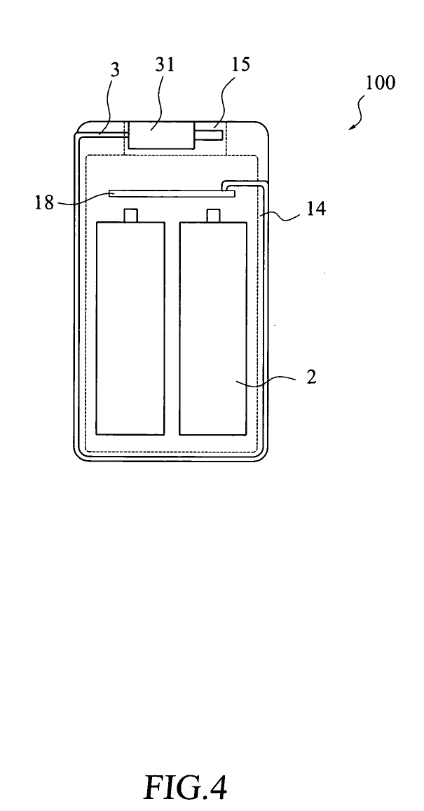

Referring to FIG. 4, FIG. 4 is a schematic diagram showing that the connection line and the output connector are placed within the shell body of the first embodiment. As shown, when the portable power supply module is not in use, the connection line 3 can be wound around the winding area 14 and received in the winding area 14 of the shell body 1, and the output connector 31 can be accommodated in the output connector accommodation room 15 of the shell body 1. The packages of the connection line 3 and output connector 15 into the shell body 1 diminish the volume occupation so as to be convenient to carry out and can protect the connection line 3 and output connector 15 from damages by other stuff.

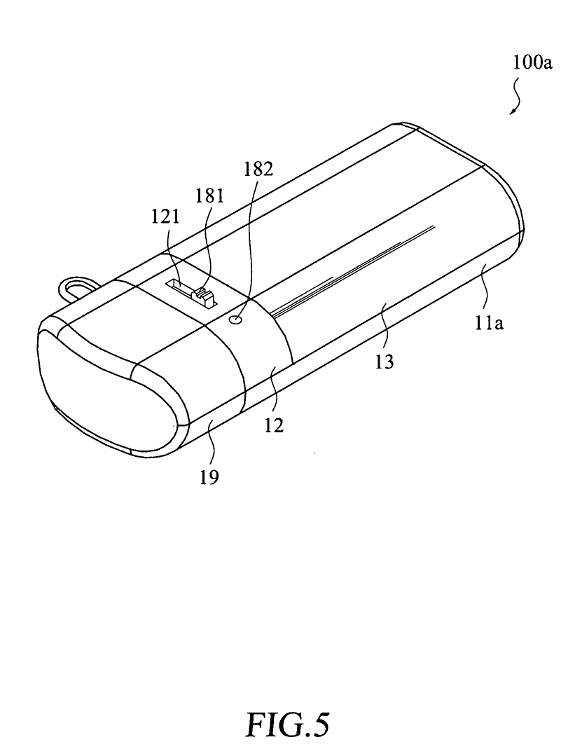

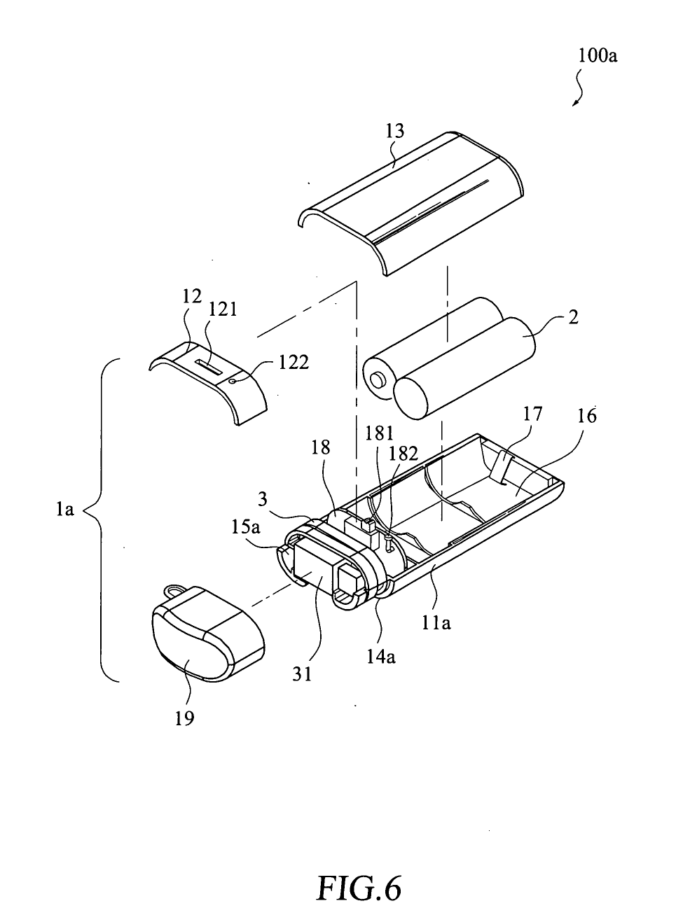

Referring to FIG. 5 and FIG. 6, FIG. 5 shows a perspective view of a portable power supply module according to a second embodiment of the present invention. FIG. 6 shows an exploded view of the portable power supply module of FIG. 5.

The second embodiment is substantially similar to the first embodiment, and like reference numerals are used to identify elements that are similar or identical in the two embodiments. As shown in the drawings, the shell body la of the present embodiment comprises a base 11a, a first lid 12, a second lid 13 and a cap 19. The shell body 1a is formed by fastening the first lid 12, the second lid 13, and the cap 19 with the base 11 correspondingly.

The differences between the second embodiment and the first embodiment reside in that the winding area 14a is located at an extension portion of the base 11a near the power switch 18 and that the output connector accommodation room 15a is located at an outward end of the extension portion. The extension portion forms a recess to act as the winding area 14a for receiving the connection line 3. The extension portion also forms an internal space of predetermined size to act as the output connector accommodation room 15a for accommodating the output connector 31, which is close to the winding area 14a. After the connection line 3 is wound around the winding area 14a and output connector 31 are placed in the connector accommodation room 15a, the cap 19 can be put to the extrusion portion of the shell body 1 to tightly fastened with the shell body 1 and completely cover the connection line 3 and output connector 31, forming a compact package. Accordingly, it protects the connection line 3 and output connector 31 from damages and makes the portable power supply module more convenient for carrying.

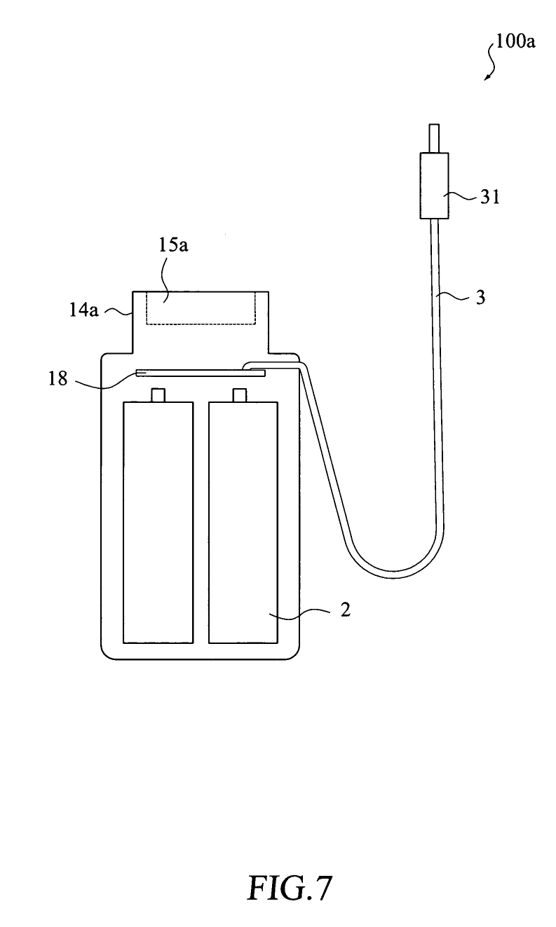

Referring to FIG. 7, FIG. 7 is a schematic diagram showing that the connection line and the output connector are pulled out of a shell body of the portable power supply module of FIG. 5. As shown in FIG. 7, when the portable power supply module 100a is in use, the connection line 3 can be taken out to facilitate the electrical connection of the output connector 31 and the electrical appliance to be charged.

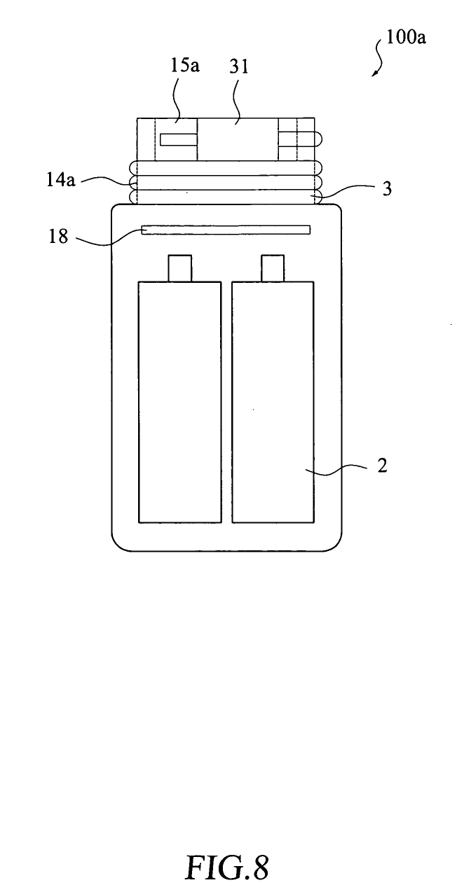

Please refer to FIG. 8, which shows that the connection line and the output connector are placed within the shell body of the portable power supply module of FIG. 5. As shown in FIG. 8, after the use of the portable power supply module, the connection line 3 is wound around and received in the winding area 14a of the shell body 1a and the output connector 31 is accommodated in the output connector accommodation room 15a of the shell body 1. With the protection of the rigid shell body 1a, the connection line 3 and output connector 31 are securely stored.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A portable power supply module, comprising:
a shell body, which is provided with a winding area and an output connector accommodation room, wherein the winding area is a groove laterally extending along the periphery of the shell body;
a battery room, which is formed in the interior of the shell body and provided with at least a set of conductive contact plates, wherein the conductive contact plates are electrically connected with a circuit board;
at least one battery unit, which is accommodated in the battery room to provide power through the conductive contact plates;
a connection line, having a predetermined extension length, which is connected with the circuit board, passes through the shell body and extends outside the shell body;
an output connector, which is connected to the connection line;
wherein the connection line is wound around and received in the winding area of the shell body and the output connector is accommodated in the output connector accommodation room of the shell body.

2. The portable power supply module as claimed in claim 1, wherein the output connector is a USB interface connection plug.

3. The portable power supply module as claimed in claim 1, wherein the shell body is provided with a power switch which is connected to the circuit board.

4. The portable electric energy supply module as claimed in claim 1, wherein the shell body is provided with a power indicating lamp which is connected to the circuit board.
